(19) United States
(12) Patent Application Publication
(10) Pub. No.: US 2026/0302159 A1
(43) Pub. Date: Oct. 1, 2026

(54) METHOD OF MANUFACTURING SOLID-STATE BATTERY

(71) Applicant: HONDA MOTOR CO., LTD., Tokyo (JP)

(72) Inventors: Takashi TOYOSHIMA, Saitama (JP); Akihiro YOSHIZAWA, Saitama (JP)

(21) Appl. No.: 19/632,431

(22) Filed: Mar. 30, 2026

(30) Foreign Application Priority Data
Mar. 31, 2025 (JP) 2025-060043
Mar. 3, 2026 (JP) 2026-033474

(51) Int. Cl. H01M 4/04; H01M 4/02; H01M 10/0585; H01M 50/586; H01M 50/593

(52) U.S. Cl. CPC H01M 4/0416; H01M 4/043; H01M 10/0585; H01M 50/586; H01M 50/593; H01M 2004/028

(57) ABSTRACT

To provide a method of manufacturing a solid-state battery that can reduce a level difference between a positive electrode layer and an insulating material with a simple configuration. The method includes: a positive electrode active material layer forming step; an insulating frame forming step; a placement step of placing the positive electrode active material layer formed in the positive electrode active material layer forming step on an inner surface side of the insulating frame formed in the insulating frame forming step; a first pressing step of pressing the insulating frame and the positive electrode active material layer after the placement step; a lamination step of laminating at least the solid electrolyte layer on the positive electrode active material layer and the insulating frame; and a second pressing step of pressing a laminate obtained in the lamination step.

This application is based on and claims the benefit of priority from Japanese Patent Application Nos. 2025-060043 and 2026-033474, respectively filed on 31 Mar. 2025 and 3 Mar. 2026, the content of which is incorporated herein by reference.

### BACKGROUND OF THE INVENTION

### Field of the Invention

The present invention relates to a method of manufacturing a solid-state battery.

### Related Art

In recent years, research and development have been conducted on secondary batteries that contribute to improving energy efficiency in order to enable a larger number of people to secure access to affordable, reliable, sustainable, and advanced energy.

As such secondary batteries, solid-state batteries such as lithium metal batteries and lithium-ion secondary batteries have been known in which a solid electrolyte layer is disposed between a positive electrode layer and a negative electrode layer. As such solid-state batteries, technology is known in which an outer edge of the positive electrode layer is covered with an insulating material (edge member) in order to improve insulation between the positive electrode layer and the negative electrode layer (for example, see Japanese Unexamined Patent Application Publication No. 2020-107500).
Patent Document 1: Japanese Unexamined Patent Application Publication No. 2020-107500

### SUMMARY OF THE INVENTION

Since both the positive electrode layer and the insulating material are individually formed by coating or the like, it is difficult to avoid the generation of a slight level difference between the positive electrode layer and the insulating material. Due to such a level difference, as disclosed in Japanese Unexamined Patent Application Publication No. 2020-107500, stress may concentrate at a level difference portion during pressing, and electrode cracking may occur. In addition to the above, from the viewpoint of improving energy density, a solid electrolyte layer laminated on the positive electrode layer and the insulating material is preferably as thin as possible. However, the solid electrolyte layer needs to have a thickness equal to or greater than a certain thickness relative to the above-described level difference. Accordingly, when the above-described level difference is large, there is a problem in that thinning of the solid electrolyte layer becomes difficult.

The technology disclosed in Japanese Unexamined Patent Application Publication No. 2020-107500 reduces the above-described level difference by providing a gap between a positive electrode material discharge port and an edge member discharge port, allowing the positive electrode material and the edge member to merge and contact with each other in a wet state during coating. Japanese Unexamined Patent Application Publication No. 2020-107500 discloses that mixing of the positive electrode material and the edge member is suppressed by disposing the positive electrode material discharge port and the edge member discharge port so as not to overlap with each other, or by forming a partition between a positive electrode material flow path and an edge member flow path. However, as long as the positive electrode material and the edge member merge in a wet state, it is not possible to completely prevent mixing between the positive electrode material and the edge member. The technology of Japanese Unexamined Patent Application Publication No. 2020-107500 involves a problem in that an apparatus for coating the positive electrode material and the edge member has a complicated configuration.

The present invention has been made in view of the above circumstances, and an object of the present invention is to provide a method of manufacturing a solid-state battery that can reduce a level difference between a positive electrode layer and an insulating material with a simple configuration.

(1) In a method of manufacturing a solid-state battery having a laminated structure in which a negative electrode layer, a solid electrolyte layer, and a positive electrode layer are laminated in this order, the positive electrode layer includes a positive electrode active material layer, and an insulating frame is disposed at an outer edge of the positive electrode active material layer in a direction orthogonal to a lamination direction of the laminated structure. The method includes: (A) a positive electrode active material layer forming step of punching and cutting out the positive electrode active material layer in a dry state; (B) an insulating frame forming step of punching and cutting out the insulating frame in a dry state; (C) a placement step of placing the positive electrode active material layer formed in the positive electrode active material layer forming step (A) on an inner surface side of the insulating frame formed in the insulating frame forming step (B); (D) a first pressing step of pressing the insulating frame and the positive electrode active material layer after the placement step (C); (E) a lamination step of laminating at least the solid electrolyte layer on the positive electrode active material layer and the insulating frame; and (F) a second pressing step of pressing a laminate obtained in the lamination step (E).

(2) In the method of manufacturing a solid-state battery as described in (1), formation of the positive electrode active material layer is entirely performed with a dry manufacturing process.

(3) In the method of manufacturing a solid-state battery as described in (1) or (2), the placement step (C) is a step of transferring the positive electrode active material layer to a positive electrode current collector layer, and subsequently transferring the insulating frame to the positive electrode current collector layer such that the positive electrode active material layer is disposed on an inner surface side of the insulating frame.

(4) In the method of manufacturing a solid-state battery as described in any one of (1) to (3), in a cross-sectional shape along the lamination direction, the positive electrode active material layer has a length of a side adjacent to the solid electrolyte layer which is shorter than a length of a side adjacent to the positive electrode current collector layer, and an angle formed between an end surface of the positive electrode active material layer and a lamination surface of the positive electrode current collector layer is between 30° and 150° inclusive.

(5) In the method of manufacturing a solid-state battery as described in (1) or (2), the placement step (C) is a step of transferring the insulating frame to a positive electrode current collector layer, and subsequently transferring the positive electrode active material layer to the positive electrode current collector layer such that the positive electrode active material layer is disposed on an inner surface side of the insulating frame.

(6) In the method of manufacturing a solid-state battery as described in (1), (2) or (5), in a cross-sectional shape along the lamination direction, the positive electrode active material layer has a length of a side adjacent to the positive electrode current collector layer which is shorter than a length of a side adjacent to the solid electrolyte layer, and an angle formed between an end surface of the positive electrode active material layer and a lamination surface of the positive electrode current collector layer is between 30° and 150° inclusive.

(7) In the method of manufacturing a solid-state battery as described in any one of (1) to (6), in the placement step (C), a gap is formed between the insulating frame and the positive electrode active material layer, and in the first pressing step (D) or the second pressing step (F), the insulating frame and the positive electrode active material layer extend and come into contact with each other.

(8) In the method of manufacturing a solid-state battery as described in any one of (1) to (6), in the placement step (C), a gap is formed between the insulating frame and the positive electrode active material layer, the gap does not disappear in the first pressing step (D), and in the lamination step (E), a solid electrolyte slurry for forming the solid electrolyte layer is applied to lamination surfaces of the insulating frame and the positive electrode active material layer, and, during application thereof, the solid electrolyte slurry flows into the gap.

(9) In the method of manufacturing a solid-state battery as described in any one of (1) to (8), a thickness of the solid electrolyte layer is between 1 μm and 40 μm inclusive.

(10) In the method of manufacturing a solid-state battery as described in any one of (1) to (9), a level difference in the lamination direction between the positive electrode active material layer and the insulating frame in the solid-state battery is equal to or less than two-thirds of a thickness of the solid electrolyte layer.

(11) In the method of manufacturing a solid-state battery as described in any one of (1) to (10), a pressing pressure in the second pressing step (F) is higher than a pressing pressure in the first pressing step (D).

(12) In the method of manufacturing a solid-state battery as described in any one of (1) to (11), a pressing pressure in the first pressing step (D) is between 10 MPa and 200 MPa inclusive.

According to the present invention, it is possible to provide a method of manufacturing a solid-state battery that can reduce a level difference between a positive electrode layer and an insulating material with a simple configuration.

### BRIEF DESCRIPTION OF THE DRAWINGS

FIG. 1 is a schematic cross-sectional diagram illustrating a configuration of a solid-state battery according to an embodiment of the present invention;

FIG. 2 is a diagram illustrating a positive electrode active material layer forming step in a manufacturing method according to an embodiment of the present invention;

FIG. 3 is a diagram illustrating an insulating frame forming step in a manufacturing method according to an embodiment of the present invention;

FIG. 4 is a diagram illustrating a placement step and a first pressing step in a manufacturing method according to an embodiment of the present invention;

FIG. 5 is a diagram illustrating a placement step in a manufacturing method according to an embodiment of the present invention;

FIG. 6 is a diagram illustrating a placement step in a manufacturing method according to an embodiment of the present invention;

FIG. 7 is a diagram illustrating a first pressing step according to an embodiment of the present invention;

FIG. 8 is a diagram illustrating a second pressing step according to an embodiment of the present invention;

FIG. 9 is a diagram illustrating a lamination step according to an embodiment of the present invention;

FIG. 10 is a diagram illustrating a lamination step according to an embodiment of the present invention;

FIG. 11 is a diagram illustrating a positive electrode active material layer forming step in a manufacturing method according to an embodiment of the present invention;

FIG. 12 is a diagram illustrating an insulating frame forming step in a manufacturing method according to an embodiment of the present invention;

FIG. 13 is a diagram illustrating a placement step in a manufacturing method according to an embodiment of the present invention;

FIG. 14 is a diagram illustrating a first pressing step according to an embodiment of the present invention;

FIG. 15 is a diagram illustrating a positive electrode active material layer forming step in a manufacturing method according to an embodiment of the present invention;

FIG. 16 is a diagram illustrating an insulating frame forming step in a manufacturing method according to an embodiment of the present invention;

FIG. 17 is a diagram illustrating a placement step in a manufacturing method according to an embodiment of the present invention;

FIG. 18 is a diagram illustrating a first pressing step according to an embodiment of the present invention;

FIG. 19 is a diagram illustrating a lamination step according to an embodiment of the present invention; and

FIG. 20 is a diagram illustrating a lamination step according to an embodiment of the present invention.

### DETAILED DESCRIPTION OF THE INVENTION

FIG. 1 is a schematic cross-sectional view illustrating a structure of a solid-state battery 1 manufactured with a method of manufacturing a solid-state battery according to the present embodiment. In each drawing, a Z direction indicates a lamination direction of layers. An X direction indicates a direction orthogonal to the lamination direction and indicates a direction in which a current collector tab extends. A Y direction indicates a direction orthogonal to the Z direction and the X direction. As illustrated in FIG. 1, the solid-state battery 1 has a laminated structure in which a negative electrode layer 2, a solid electrolyte layer 4, and a positive electrode layer 3 are laminated in this order. An intermediate layer 5 may be optionally laminated between the negative electrode layer 2 and the solid electrolyte layer 4. FIG. 1 illustrates an example of a solid-state battery using the solid electrolyte layer 4, and a configuration of the solid-state battery is not limited to the configuration illustrated in FIG. 1. For example, in the configuration illustrated in FIG. 1, two negative electrode layers 2 and one positive electrode layer 3 are illustrated; however, the number of laminated layers of each layer in the solid-state battery 1 is not limited to the configuration illustrated in FIG. 1. The solid-state battery 1 may be a lithium-ion solid-state secondary battery or may be a lithium metal secondary battery. The configuration of the solid-state battery of the present invention can be applied to other types of solid-state batteries as long as the application does not depart from the gist of the present invention. For example, the configuration of the present invention can also be applied to a battery having a structure in which cells are connected in series inside the battery (such as a bipolar battery). An example of application to a bipolar battery according to the present invention is a structure in which the current collector 32 in FIG. 1 is used as a bipolar current collector and different types of electrode layers are laminated on both surfaces.

### Negative Electrode Layer

The negative electrode layer 2 includes a negative electrode active material layer 21 and a negative electrode current collector layer 22. The negative electrode active material layer 21 is not particularly limited and can be constituted by a material that can be used as a negative electrode active material of a solid-state battery. The negative electrode active material layer 21 is preferably a lithium metal or lithium alloy layer in which a negative electrode active material is lithium metal or a lithium alloy. This is because, in the solid-state battery 1 according to the present embodiment, even in a case where lithium metal or a lithium alloy is melted, a short circuit can be preferably prevented by the insulating frame 6. The lithium metal alloy is not particularly limited as long as the lithium metal alloy can be alloyed with lithium, and examples of metals that can be alloyed with lithium include at least one metal selected from the group consisting of Sn, Ag, Mg, In, Si, Al, Bi, Sb, Zn, and Cu. In addition to the above, the negative electrode active material layer 21 may be constituted by a silicon-based active material such as Si or a Si alloy, a lithium transition metal oxide such as lithium titanate (Li₄Ti₅O₁₂), a transition metal oxide such as TiO₂, Nb₂O₃, or WO₃, a metal sulfide, a metal nitride, a carbon material such as graphite, soft carbon, or hard carbon, or metallic indium.

In addition to the above, the negative electrode active material layer 21 may include a material that can be contained in a negative electrode active material layer of a solid-state battery. Examples of such materials include a solid electrolyte, a conductive auxiliary agent, and a binder. Examples of the conductive auxiliary agent include carbon black, natural graphite, carbon fiber, and carbon nanotubes. Examples of the solid electrolyte and the binder include the same solid electrolyte material and binder as those contained in a solid electrolyte layer 4 described below.

Although not particularly limited thereto, the negative electrode current collector layer 22 can be constituted by copper, nickel, stainless steel, or the like. Examples of the shape of the negative electrode current collector layer 22 include a foil shape, a plate shape, a mesh shape, a nonwoven fabric shape, and a foamed shape. A part of the negative electrode current collector layer 22 extends in a predetermined direction to constitute a negative electrode current collector tab 22a.

### Positive Electrode Layer

The positive electrode layer 3 includes a positive electrode active material layer 31 and a positive electrode current collector layer 32. In the present embodiment, the positive electrode layer 3 has a configuration in which two positive electrode active material layers 31 are laminated on both surfaces of one positive electrode current collector layer 32. However, the positive electrode layer 3 is not limited to the above configuration, and may have a configuration in which one positive electrode active material layer 31 is laminated on one surface of one positive electrode current collector layer 32.

The positive electrode active material layer 31 is not particularly limited and can be constituted by a material that can be used as a positive electrode active material of a solid-state battery. Examples of positive electrode active materials constituting the positive electrode active material layer 31 include layered positive electrode active material particles such as LiCoO₂, LiNiO₂, LiCoxNiyMnzO₂ (x+y+z=1), LiVO₂, and LiCrO₂, spinel-type positive electrode active materials such as LiMn₂O₄, Li(Ni_{0.25}Mn_{0.75})₂O₄, LiCoMnO₄, and Li₂NiMn₃O₈, olivine-type positive electrode active materials such as LiCoPO₄, LiMnPO₄, and LiFePO₄, solid solution oxides (Li₂MnO₃—LiMO₂ (M=Co, Ni, or the like)), conductive polymers such as polyaniline and polypyrrole, sulfides such as Li₂S, CuS, Li—Cu—S compounds, TiS₂, FeS, MoS₂, and Li—Mo—S compounds, and a mixture of sulfur and carbon. The positive electrode active material may be constituted by one of the above materials, or may be constituted by two or more of the above materials.

In addition to the above, the positive electrode active material layer 31 may include materials that can be contained in a positive electrode active material layer of a solid-state battery, such as a solid electrolyte, a conductive auxiliary agent, and a binder. Examples of the conductive auxiliary agent include carbon black, natural graphite, carbon fiber, and carbon nanotubes. Examples of the solid electrolyte and the binder include the same solid electrolyte material and binder as those contained in the solid electrolyte layer 4 described below.

Although not particularly limited thereto, the positive electrode current collector layer 32 can be constituted by, for example, aluminum, stainless steel, or conductive carbon such as graphite or carbon nanotubes. Examples of a shape of the positive electrode current collector layer 32 include a foil shape, a plate shape, a mesh shape, a nonwoven fabric shape, and a foamed shape. A part of the positive electrode current collector layer 32 extends in a predetermined direction to constitute a positive electrode current collector tab 32a.

### Insulating Frame

An insulating frame 6 is provided at an outer edge of the positive electrode active material layer 31 in a direction orthogonal to the lamination direction. The insulating frame 6 can prevent a short circuit of the solid-state battery 1 and can improve strength. In the present embodiment, the insulating frame 6 is disposed so as to cover outer edges of the two positive electrode active material layers 31 formed on both surfaces of the positive electrode current collector layer 32. The insulating frame 6 only needs to be provided so that the positive electrode active material layer 31 is not exposed to the outside. The insulating frame 6 and the positive electrode active material layer 31 may be in contact with each other, or may be separated from each other. In a case where the insulating frame 6 and the positive electrode active material layer 31 are separated from each other, the solid electrolyte layer 4 may be present between the insulating frame 6 and the positive electrode active material layer 31. The insulating frame 6 may be in contact with a part of a lamination surface of the positive electrode current collector layer 32, and may have a structure in which the positive electrode current collector tab 32a extends.

Although the material constituting the insulating frame 6 only needs to have insulating properties and is not particularly limited, examples of the material include insulating oxides such as alumina, silica, and zirconia, resins such as polyvinylidene fluoride (PVDF), and rubbers such as styrene-butadiene rubber (SBR).

The insulating frame 6 and the positive electrode active material layer 31 are both formed on the positive electrode current collector layer 32. Since the insulating frame 6 and the positive electrode active material layer 31 are layers individually formed, a slight difference (level difference) may occur in a length (thickness) in the lamination direction. When the level difference is excessively large, cracks may occur in respective layers during pressing in manufacturing the solid-state battery 1. The solid electrolyte layer 4 is formed between the insulating frame 6 and the positive electrode active material layer 31, and the negative electrode layer 2. In order for the solid electrolyte layer 4 to exhibit a function, a length (thickness) of the solid electrolyte layer 4 in the lamination direction needs to be designed to be thicker than the above-described level difference. On the other hand, in order to improve the energy density of the solid-state battery 1, the solid electrolyte layer 4 needs to be thin. Accordingly, the level difference between the insulating frame 6 and the positive electrode active material layer 31 (a difference in length in the lamination direction) is preferably as small as possible. The level difference is preferably equal to or less than two-thirds of the thickness of the solid electrolyte layer 4.

### Solid Electrolyte Layer

In the present embodiment, the solid electrolyte layer 4 is laminated between the intermediate layer 5 and the positive electrode layer 3. FIG. 1 illustrates a state in which one solid electrolyte layer 4 is laminated between the intermediate layer 5 and the positive electrode layer 3; however, the number of solid electrolyte layers 4 laminated between the intermediate layer 5 and the positive electrode layer 3 is not limited to one. For example, the number of laminated solid electrolyte layers 4 may be two, or may be three or more. In a case where the solid-state battery 1 does not include the intermediate layer 5, the solid electrolyte layer 4 may be laminated between the negative electrode layer 2 and the positive electrode layer 3. The solid electrolyte layer 4 includes a solid electrolyte material. The solid electrolyte material is not particularly limited, and examples of the solid electrolyte material include inorganic solid electrolytes such as a sulfide solid electrolyte material, an oxide solid electrolyte material, a halide solid electrolyte, and a lithium-containing salt, and polymer-based solid electrolytes such as polyethylene oxide. One type of the solid electrolyte material may be used, or two or more types of the solid electrolyte materials may be used in combination.

The solid electrolyte layer 4 may include a binder in addition to the solid electrolyte material described above. Examples of the binder include a fluorine-based resin, a nitrile-based polymer, a polyester-based polymer, an acrylic acid-based polymer, a cellulose-based polymer, a styrene-based polymer, a styrene-butadiene-based polymer, a vinyl acetate-based polymer, and a urethane-based polymer. One type of the binder may be used, or two or more types of the binders may be used in combination.

The thickness of the solid electrolyte layer 4 in the lamination direction is preferably between 1 μm and 40 μm inclusive, and more preferably between 3 μm and 40 μm inclusive. Accordingly, the energy density of the solid-state battery 1 can be improved. In the solid-state battery 1 of the present embodiment, the level difference in the lamination direction between the positive electrode active material layer 31 and the insulating frame 6 can be set to be equal to or less than two-thirds of the thickness of the solid electrolyte layer 4. Therefore, even in a case where the thickness of the solid electrolyte layer 4 in the lamination direction is within the above-described range, the function of the solid electrolyte layer 4 can be ensured.

### Intermediate Layer

The intermediate layer 5 is optionally disposed between the negative electrode layer 2 and the solid electrolyte layer 4. The intermediate layer 5 is a layer having lithium-ion conductivity. For example, when the solid-state battery 1 is a lithium metal battery, the intermediate layer 5 has a function of uniformly depositing lithium metal (dendrites). The solid-state battery 1 may be an anode-free battery in which the negative electrode active material layer 21 is not present at an initial stage. In this case, after the initial charge and discharge, a lithium metal layer as the negative electrode active material layer 21 is formed. The number of intermediate layers 5 is not particularly limited.

Although the material constituting the intermediate layer 5 is not particularly limited, examples of the material include a metal capable of alloying with lithium, graphite, and amorphous carbon. Examples of the metal capable of alloying with lithium include tin (Sn), silicon (Si), zinc (Zn), indium (In), magnesium (Mg), gold (Au), platinum (Pt), palladium (Pd), silver (Ag), aluminum (Al), bismuth (Bi), and antimony (Sb). These metals may be composited with carbon. The metal capable of alloying with lithium may be in the form of nanoparticles. Examples of the amorphous carbon include carbon blacks such as acetylene black, furnace black, and Ketjen black, coke, and activated carbon. The amorphous carbon may be graphitizable carbon (soft carbon), non-graphitizable carbon (hard carbon), carbon nanotubes (CNT), fullerenes, or graphene. The intermediate layer 5 may include a binder in addition to the above-described materials. As the binder, a material similar to a binder that may be contained in the solid electrolyte layer 4 can be used.

### Method of Manufacturing Solid-State Battery

### First Embodiment

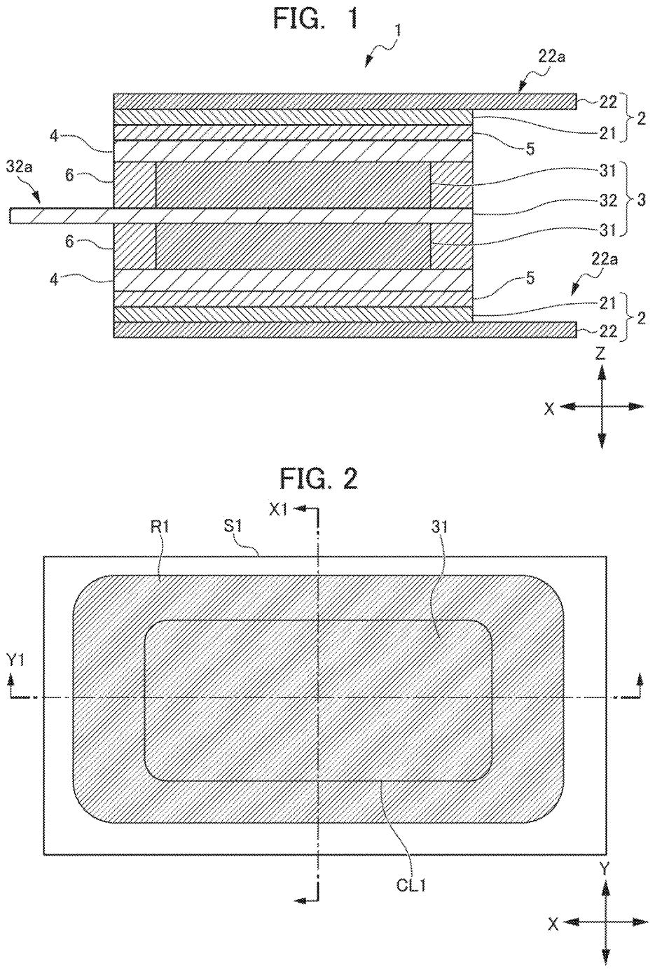

A method of manufacturing the solid-state battery 1 according to the present embodiment is exemplified below. The method of manufacturing the solid-state battery 1 according to the present embodiment includes a positive electrode active material layer forming step of punching and cutting out the positive electrode active material layer 31 in a dry state. FIG. 2 is an example of the positive electrode active material layer forming step, and is a plan view (schematic diagram) illustrating a state in which the positive electrode active material layer 31 is formed on a transfer sheet S1. As a method of forming the positive electrode active material layer 31 in a dry state on the transfer sheet S1, a dry manufacturing process can be employed. The positive electrode active material layer 31 may be entirely formed with the dry manufacturing process. The dry manufacturing process is a method of forming the positive electrode active material layer 31 by granulating and compressing a positive electrode active material, a binder, and other components constituting the positive electrode active material layer, without using a solvent. Such methods are not particularly limited, and known granulation methods and compression methods can be used.

As a method of forming the positive electrode active material layer 31 in a dry state on the transfer sheet S1, a method other than the above-described dry manufacturing process may be used. For example, a method may be used in which the components constituting the positive electrode active material layer 31 are dissolved or dispersed in a solvent to form a slurry, the slurry is applied onto the transfer sheet S1, and then dried. In the present specification, a dry state indicates a state in which the components constituting a layer do not flow. The dry state may be a state substantially free of volatile components at room temperature. The content of the volatile components in the dry state may be 5% or less, may be 3% or less, may be 1% or less, or may be 0.1% or less.

After forming the positive electrode active material layer 31 in a dry state on the transfer sheet S1, as illustrated in FIG. 2, a cut is made along CL1 such that the positive electrode active material layer 31 has a predetermined size. Thereafter, by removing an excess portion R1, the positive electrode active material layer 31 having the predetermined size can be punched out and formed on the transfer sheet S1.

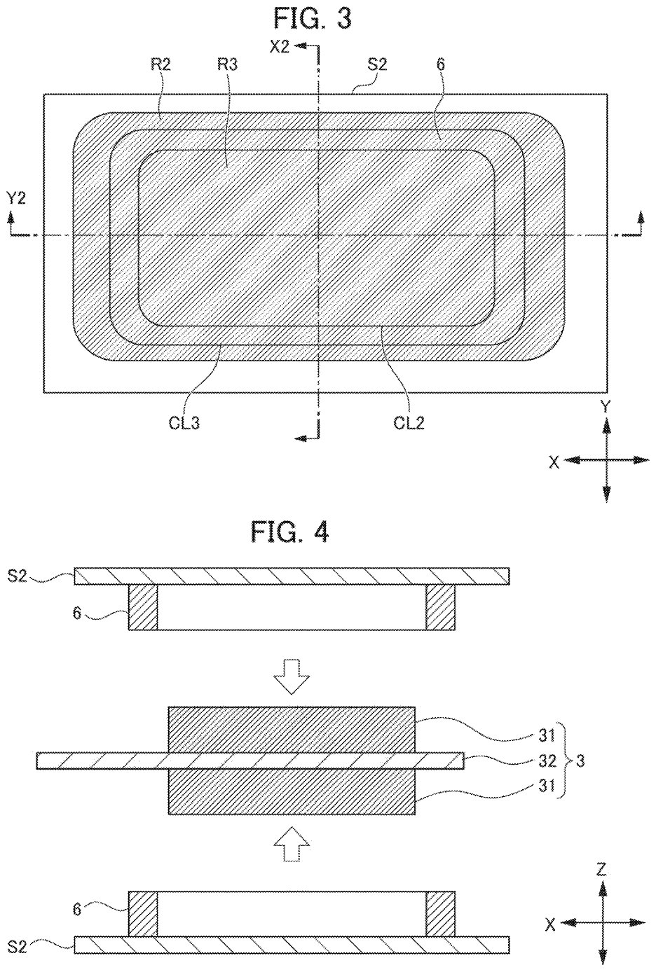

The method of manufacturing the solid-state battery 1 according to the present embodiment includes an insulating frame forming step of punching and cutting out the insulating frame 6 in a dry state. FIG. 3 is an example of the insulating frame forming step, and is a plan view (schematic diagram) illustrating a state in which the insulating frame 6 is formed on a transfer sheet S2. As a method of forming the insulating frame 6 in a dry state on the transfer sheet S2, similar to the positive electrode active material layer forming step, a dry manufacturing process or a process in which a slurry is applied and then dried can be employed.

After forming the insulating frame 6 in a dry state on the transfer sheet S2, as illustrated in FIG. 3, cuts are made along CL2 and CL3 such that the insulating frame 6 has a predetermined size. Thereafter, by removing excess portions R2 and R3, the insulating frame 6 having the predetermined size can be punched out and formed on the transfer sheet S2.

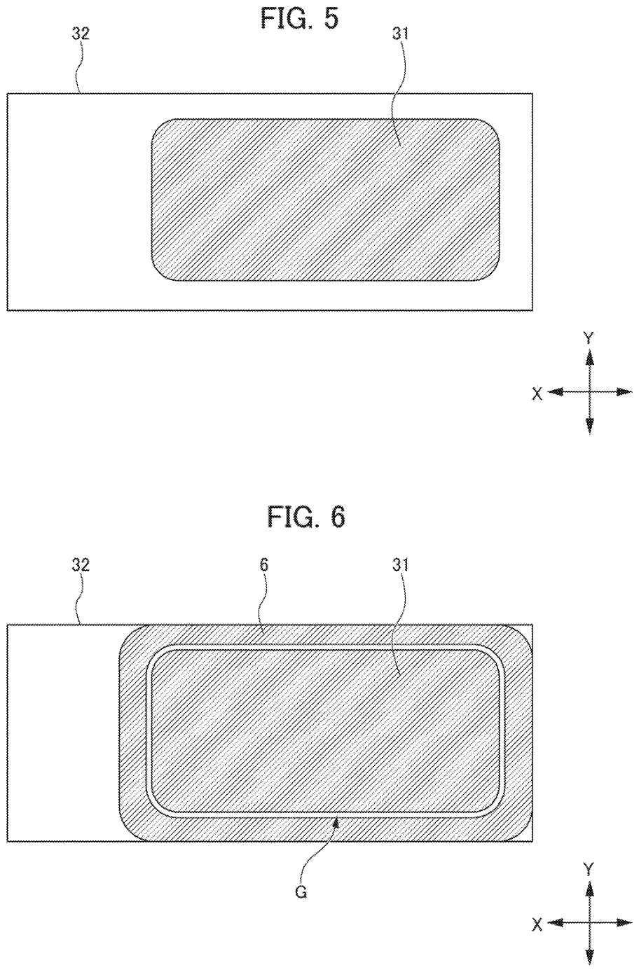

The method of manufacturing the solid-state battery 1 according to the present embodiment includes a placement step of placing the positive electrode active material layer 31 on an inner surface side of the insulating frame 6 obtained by the positive electrode active material layer forming step and the insulating frame forming step described above. In the placement step, the positive electrode active material layer 31 in a dry state and the insulating frame 6 in a dry state are respectively disposed on the positive electrode current collector layer 32. If assuming that at least one of the positive electrode active material layer 31 and the insulating frame 6 is formed on the positive electrode current collector layer 32 by coating, one layer may partially ride over the other layer at a boundary between the two layers, whereby a large level difference tends to be generated. In the placement step of the present embodiment, by disposing two layers in a dry state, the above-described level difference can be reduced at low cost. The placement step may be a step in which, as illustrated in FIG. 5, the positive electrode active material layer 31 is transferred onto the positive electrode current collector layer 32 and, thereafter, as illustrated in FIG. 6, the insulating frame 6 is transferred onto the positive electrode current collector layer 32. Conversely, a step in which transfer of the insulating frame 6 onto the positive electrode current collector layer 32 is performed first may be employed.

In the placement step, as illustrated in FIG. 6, a gap G is preferably formed between the insulating frame 6 and the positive electrode active material layer 31. By a first pressing step or a second pressing step described below, the insulating frame 6 and the positive electrode active material layer 31 extend in a direction orthogonal to the lamination direction (pressing direction). Accordingly, the gap G is preferably set in consideration of a degree of extension of the insulating frame 6 and the positive electrode active material layer 31 by the first pressing step or the second pressing step. For example, the size of the gap G may be set such that the positive electrode active material layer 31 extends and comes into contact with the insulating frame 6 by the first pressing step or the second pressing step. When the positive electrode active material layer 31 and the insulating frame 6 come into contact with each other, the gap G disappears, and the energy density of the solid-state battery 1 can be improved.

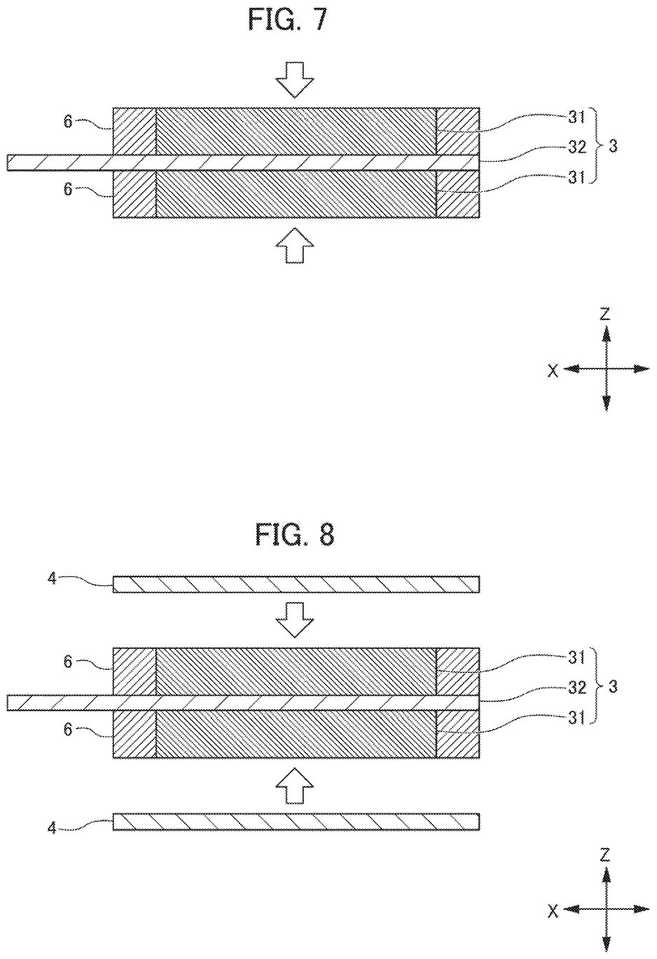

The first pressing step is a step of pressing the insulating frame 6 and the positive electrode active material layer 31 after the placement step. For example, as illustrated in FIG. 4, the first pressing step is a step of transferring the insulating frame 6 provided on the transfer sheet S2 onto the positive electrode current collector layer 32 to which the positive electrode active material layer 31 has been transferred, and pressing with a predetermined pressing pressure from the lamination direction. In this case, the placement step and the first pressing step may constitute a single step. After the first pressing step, the transfer sheet S2 is removed. FIG. 4 illustrates, as the first pressing step, a step of disposing two insulating frames 6 and pressing with respect to the positive electrode current collector layer 32 to which two positive electrode active material layers 31 have been transferred on both lamination surfaces. The first pressing step is not limited to the aspect illustrated in FIG. 4, and may be a step of disposing one insulating frame 6 and pressing with respect to the positive electrode current collector layer 32 to which one positive electrode active material layer 31 has been transferred on one lamination surface. As illustrated in FIG. 7, the first pressing step may be a step separate from the placement step, in which the insulating frame 6 and the positive electrode active material layer 31 are separately pressed after the placement step. By the first pressing step or a second pressing step described below, pressing may be performed such that the gap G between the insulating frame 6 and the positive electrode active material layer 31 disappears.

The pressing pressure in the first pressing step only needs to be a pressure at which the positive electrode active material layer 31 and the insulating frame 6 can be transferred, and is preferably performed at a temperature between 25° C. and 120° C. inclusive and at a pressure between 10 MPa and 200 MPa inclusive. Accordingly, the positive electrode active material layer 31 can be appropriately densified and can be preferably integrated with the positive electrode current collector layer 32 and the insulating frame 6.

The method of manufacturing the solid-state battery 1 according to the present embodiment includes a lamination step of laminating the solid electrolyte layer 4 on a lamination surface of the positive electrode active material layer 31 and the insulating frame 6 opposite to a positive electrode current collector layer 32 side, after the first pressing step. The lamination step may be, for example, a step of preparing a slurry obtained by dispersing the materials constituting the solid electrolyte layer 4 in a solvent, applying the slurry to the lamination surfaces of the positive electrode active material layer 31 and the insulating frame 6, and drying the slurry. Alternatively, the lamination step may be a step of disposing a solid electrolyte layer 4 that has been formed in advance into a sheet shape on the lamination surfaces.

The method of manufacturing the solid-state battery 1 according to the present embodiment includes a second pressing step of pressing a laminate obtained by the lamination step at a predetermined pressure. The lamination step and the second pressing step may be, as illustrated in FIG. 8, steps of disposing two solid electrolyte layers 4 on lamination surfaces of two positive electrode active material layers 31 and the insulating frame 6, and pressing the two solid electrolyte layers 4.

A pressing pressure in the second pressing step is preferably higher than a pressing pressure in the first pressing step. Accordingly, respective layers can be preferably densified and integrated. The pressing pressure in the second pressing step is preferably performed at a temperature between 25° C. and 120° C. inclusive and at a pressure between 200 MPa and 1200 MPa inclusive.

The method of manufacturing the solid-state battery 1 according to the present embodiment may optionally include steps other than those described above. For example, the method may include a step of laminating other layers constituting the solid-state battery 1, such as the intermediate layer 5 or the negative electrode layer 2, on the laminate obtained by the second pressing step, a step of pressing respective layers individually, or an integration pressing step of pressing after integrating respective layers. The pressing pressure in the integration pressing step may be, for example, performed at a temperature between 25° C. and 120° C. inclusive and at a pressure between 200 MPa and 1200 MPa inclusive. By setting the pressing pressure in the integration pressing step within the above-described range, respective layers can be densified, and the energy density of the solid-state battery 1 can be improved.

Hereinafter, methods of manufacturing a solid-state battery according to other embodiments of the present invention will be described. Descriptions of contents similar to those of the first embodiment described above are omitted.

### Second Embodiment

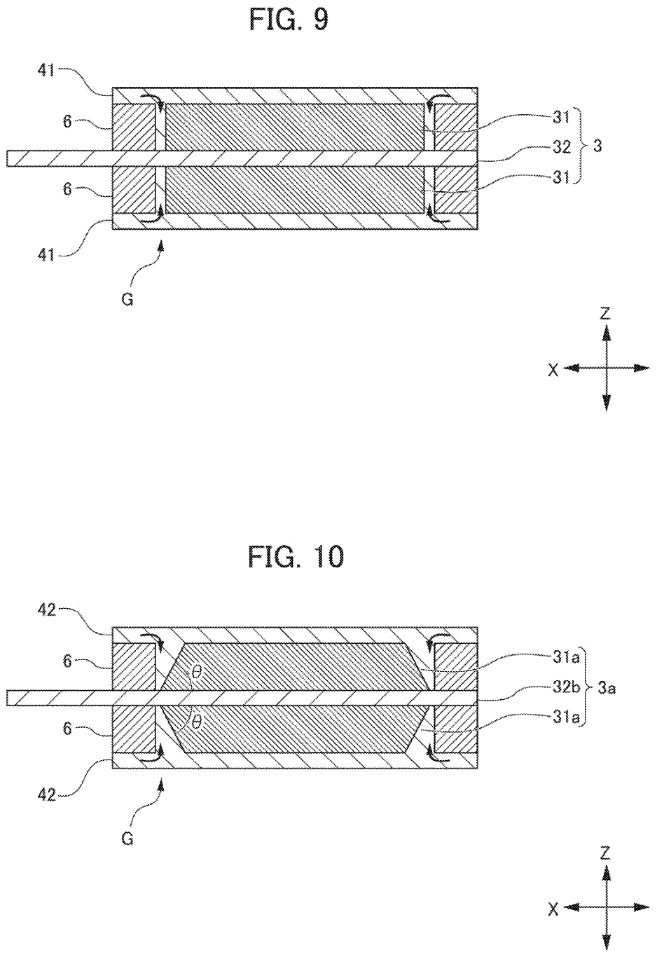

In the method of manufacturing a solid-state battery according to the present embodiment, a gap G between the insulating frame 6 and the positive electrode active material layer 31 does not disappear, but remains after the first pressing step. In the lamination step of the present embodiment, a solid electrolyte slurry obtained by dispersing the materials constituting the solid electrolyte layer 4 in a solvent is applied to the lamination surfaces of the positive electrode active material layer 31 and the insulating frame 6, and then dried. Accordingly, as illustrated in FIG. 9, during application of the solid electrolyte slurry 41 in the placement step, the solid electrolyte slurry 41 flows into the gap G.

In the first pressing step, since the gap G can be allowed to remain, it is not necessary to strictly set a size of the gap G or a pressing pressure in the first pressing step in consideration of a degree of extension of the insulating frame 6 and the positive electrode active material layer 31. Since the solid electrolyte layer 4 can be formed in the gap G, the gap G can contribute to charge and discharge of the solid-state battery 1. Accordingly, a solid-state battery having high energy density and/or high output density can be easily manufactured.

### Third Embodiment

The method of manufacturing a solid-state battery according to the present embodiment includes a positive electrode active material layer forming step of punching and cutting out a positive electrode active material layer 31a in a dry state. As illustrated in FIG. 10, the positive electrode active material layer 31a has a substantially trapezoidal shape in a cross-sectional shape along the lamination direction. In the cross-sectional shape, a length of a side on a solid electrolyte layer 42 side is smaller than a length of a side on a positive electrode current collector layer 32b side. That is, an area of a lamination surface of the positive electrode active material layer 31a that comes into contact with the solid electrolyte layer 42 is smaller than an area of a lamination surface that comes into contact with the positive electrode current collector layer 32b. Accordingly, the battery resistance of the solid-state battery can be reduced. When the area of the lamination surface of the positive electrode active material layer 31a that comes into contact with the positive electrode current collector layer 32b is relatively large, the output density can be further improved in a case where a battery reaction is limited by electron conduction. Since a spacing is formed between lamination surfaces of the insulating frame 6 and the positive electrode active material layer 31a on a solid electrolyte layer 42 side, a level difference between the insulating frame 6 and the positive electrode active material layer 31a can be reduced.

As illustrated in FIG. 10, an angle θ formed between an end surface of the positive electrode active material layer 31a and a lamination surface of the positive electrode current collector layer 32b is preferably 30° or more and less than 90°, from the viewpoint of achieving the above-described effects. The angle θ is more preferably 30° or more and less than 70°. The above-described positive electrode active material layer forming step can be realized, for example, by setting an angle of a blade for punching the positive electrode active material layer 31a with respect to the positive electrode current collector layer 32b to the above-described angle θ.

The method of manufacturing a solid-state battery according to the present embodiment includes a placement step of placing the positive electrode active material layer 31a on an inner surface side of the insulating frame 6. The placement step is preferably a step of transferring the positive electrode active material layer 31a onto the positive electrode current collector layer 32b as illustrated in FIG. 5 and, thereafter, transferring the insulating frame 6 onto the positive electrode current collector layer 32b as illustrated in FIG. 6. As described above, the positive electrode active material layer 31a has a substantially trapezoidal shape in a cross-sectional shape along the lamination direction. Accordingly, when the insulating frame 6 is transferred to an outer surface side of the positive electrode active material layer 31a, contact between the two layers can be suppressed, and thus the insulating frame 6 can be easily transferred.

In the placement step, as illustrated in FIG. 10, a gap G may be formed between the insulating frame 6 and the positive electrode active material layer 31a. The gap G between the insulating frame 6 and the positive electrode active material layer 31a may remain without disappearing even by the first pressing step. The lamination step may be, similarly to the second embodiment, a step of applying a solid electrolyte slurry obtained by dispersing the materials constituting the solid electrolyte layer 42 in a solvent to lamination surfaces of the positive electrode active material layer 31a and the insulating frame 6, and drying the solid electrolyte slurry. At this time, during application of the solid electrolyte slurry, the solid electrolyte slurry flows into the gap G. As illustrated in FIG. 10, since the gap G is widened on a solid electrolyte layer 42 side, the solid electrolyte slurry can easily flow into the gap G.

### Fourth Embodiment

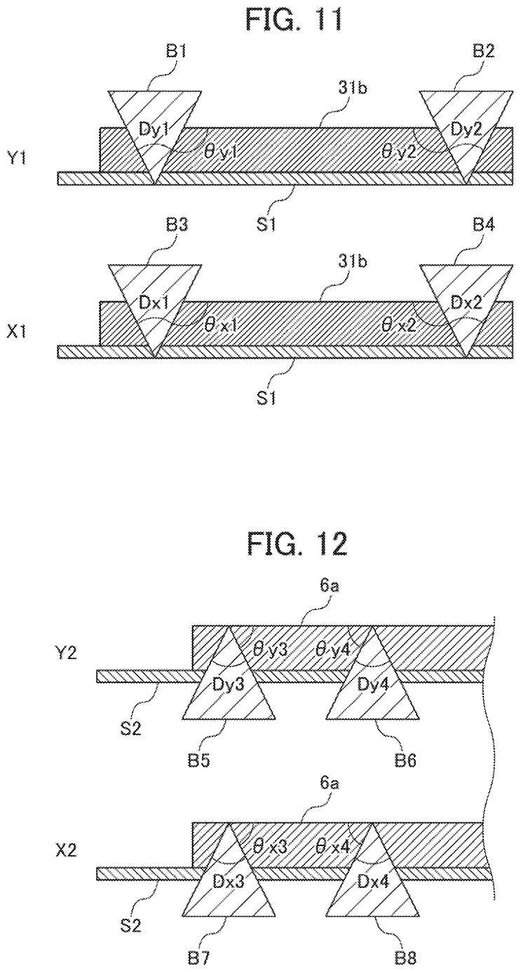

A method of manufacturing a solid-state battery according to the present embodiment will be described with reference to FIGS. 11 to 14. The method of manufacturing a solid-state battery according to the present embodiment includes a positive electrode active material layer forming step of punching and cutting out a positive electrode active material layer 31b in a dry state. FIG. 11 corresponds to an X1 cross-sectional view and a Y1 cross-sectional view in FIG. 2. FIG. 11 is a diagram schematically illustrating a step of punching the positive electrode active material layer 31b in a dry state formed on the transfer sheet S1 by blades B1, B2, B3, and B4 (positive electrode active material layer forming step). In the present embodiment, the blades B1, B2, B3, and B4 are driven from a surface opposite to a surface on which the transfer sheet S1 is present, and the positive electrode active material layer 31b is punched out. As illustrated in FIG. 11, the positive electrode active material layer 31b has a substantially trapezoidal shape in a cross-sectional shape along the lamination direction. As illustrated in FIG. 14, the positive electrode active material layer 31b has a side without the transfer sheet S1 as a side that comes into contact with the positive electrode current collector layer 32, and a side with the transfer sheet S1 as a side that comes into contact with a solid electrolyte layer. In the cross-sectional shape, a length of a side on a solid electrolyte layer 42 side is greater than a length of a side on a positive electrode current collector layer 32 side. That is, an area of a lamination surface of the positive electrode active material layer 31b that comes into contact with the solid electrolyte layer 42 is larger than an area of a lamination surface that comes into contact with the positive electrode current collector layer 32. Accordingly, when a battery reaction is limited by ion conduction, the output density can be further improved.

As illustrated in FIG. 11, angles θy1, θy2, θx1, and θx2 formed between end surfaces of the positive electrode active material layer 31b and a lamination surface of the positive electrode current collector layer 32 (hereinafter, the angles may be referred to as “cross-sectional angles”) can be determined by blade angles Dy1, Dy2, Dx1, and Dx2 of the blades B1, B2, B3, and B4. Specifically, based on the relationship of an equation: 90°+½Dy1=θy1, the cross-sectional angle θy1 can be determined from the blade angle Dy1 (the same applies to other combinations of blade angles and cross-sectional angles, such as Dy2 and θy2). The relationship between the blade angle and the cross-sectional angle described above is applicable to a case where a symmetrical blade having a V shape in cross section is driven along the lamination direction. In a case where a single-edge blade is used, it is sufficient to simply adjust the insertion angle such that a desired cross-sectional angle is obtained. The same applies to the following description. The cross-sectional angles θy1, θy2, θx1, and θx2 can be set to arbitrary angles. The cross-sectional angles may be set to correspond to cross-sectional angles of an insulating frame 6a described below, or may be angles unique to the positive electrode active material layer 31b. The cross-sectional angles may all be the same angle, or may be different angles from each other. In the present embodiment, an example is illustrated in which each of the cross-sectional angles (inner angles) exceeds 90°. Each of the cross-sectional angles (inner angles) can be set to, for example, 150° or less.

The method of manufacturing a solid-state battery according to the present embodiment includes an insulating frame forming step of punching and cutting out an insulating frame 6a in a dry state. FIG. 12 corresponds to part of an X2 cross-sectional view and a Y2 cross-sectional view in FIG. 3. That is, FIG. 12 illustrates the insulating frame 6a on one end side in each of the X2 cross-sectional view and the Y2 cross-sectional view in FIG. 3, and the following description also applies to the insulating frame 6a on the other end side. FIG. 12 is a diagram schematically illustrating a step of punching the insulating frame 6a in a dry state formed on the transfer sheet S2 by blades B5, B6, B7, and B8 (insulating frame forming step). In the present embodiment, the blades B5, B6, B7, and B8 are driven from a surface on which the transfer sheet S2 of the insulating frame 6a is present, and the insulating frame 6a is punched out together with the transfer sheet S2. As illustrated in FIG. 12, the insulating frame 6a has a substantially trapezoidal shape in a cross-sectional shape along the lamination direction. As illustrated in FIG. 14, the insulating frame 6a has a side without the transfer sheet S2 as a side that comes into contact with the positive electrode current collector layer 32, and a side with the transfer sheet S2 as a side that comes into contact with a solid electrolyte layer.

As illustrated in FIG. 12, angles θy3, θy4, θx3, and θx4 formed between end surfaces of the insulating frame 6a and a lamination surface of the positive electrode current collector layer 32 (hereinafter, the angles may be referred to as “cross-sectional angles”) can be determined by blade angles Dy3, Dy4, Dx3, and Dx4 of the blades B5, B6, B7, and B8. Specifically, based on the relationship of an equation: 90°−½Dy3 =θy3, the cross-sectional angle θy3 can be determined from the blade angle Dy3 (the same applies to other combinations of blade angles and cross-sectional angles, such as Dy4 and θy4). The cross-sectional angles θy3, θy4, θx3, and θx4 can be set to arbitrary angles. The cross-sectional angles may be set to correspond to the cross-sectional angles of the positive electrode active material layer 31b described above, or may be angles unique to the insulating frame 6a. The cross-sectional angles may all be the same angle or may be different angles from each other. In the present embodiment, an example is illustrated in which each of the cross-sectional angles (inner angles) is less than 90° and is set to correspond to the cross-sectional angles of the positive electrode active material layer 31b. Each of the cross-sectional angles (inner angles) can be set to, for example, 30° or more.

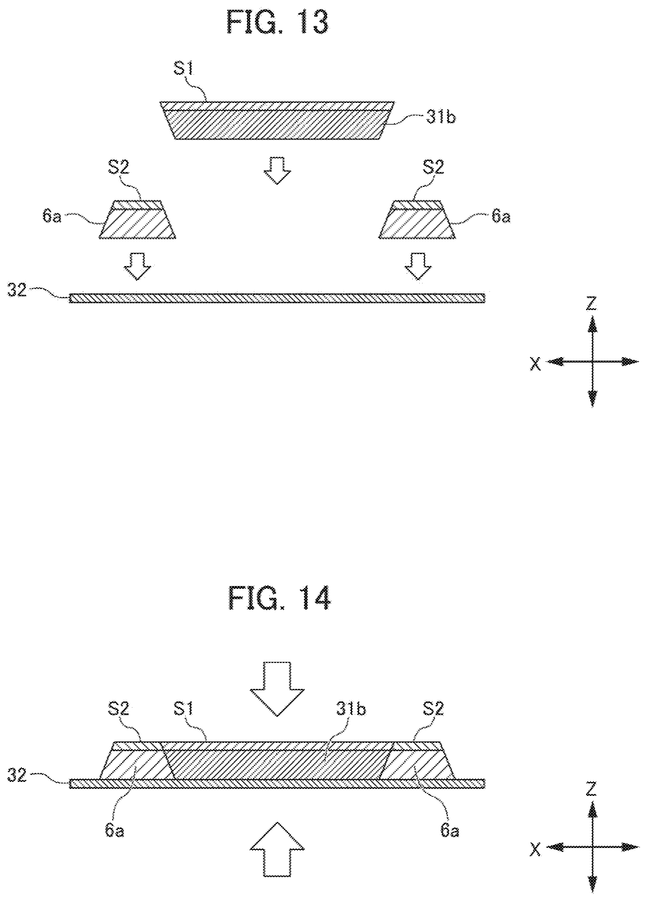

FIG. 13 is a schematic cross-sectional view along the lamination direction, and illustrates a placement step of placing the positive electrode active material layer 31b on an inner surface side of the insulating frame 6a obtained by the positive electrode active material layer forming step and the insulating frame forming step described above. In the present embodiment, first, the insulating frame 6a is disposed on the positive electrode current collector layer 32 and, thereafter, the positive electrode active material layer 31b is disposed on the positive electrode current collector layer 32 and on the inner surface side of the insulating frame 6a. In the present embodiment, each of the cross-sectional angles (inner angles) of the positive electrode active material layer 31b exceeds 90°, and each of the cross-sectional angles (inner angles) of the insulating frame 6a is less than 90°. Accordingly, the positive electrode active material layer 31b can be easily disposed on the inner surface side of the insulating frame 6a.

FIG. 14 is a schematic cross-sectional view along the lamination direction, and illustrates a first pressing step of pressing the insulating frame 6a and the positive electrode active material layer 31b after the placement step. FIG. 14 illustrates a state in which the insulating frame 6a and the positive electrode active material layer 31b are disposed on one surface of the positive electrode current collector layer 32; however, similarly to the above-described embodiments, the first pressing step may be performed in a state in which the insulating frame 6a and the positive electrode active material layer 31b are disposed on both surfaces of the positive electrode current collector layer 32. In the first pressing step, pressing is preferably performed without removing the transfer sheets S1 and S2, and the transfer sheets S1 and S2 are removed after pressing. By the first pressing step or a second pressing step thereafter, pressing may be performed such that a gap between the positive electrode active material layer 31b and the insulating frame 6a disappears. Accordingly, the energy density and/or the output density of the solid-state battery can be improved. In the present embodiment, the cross-sectional angles of the insulating frame 6a are set to correspond to the cross-sectional angles of the positive electrode active material layer 31b. Accordingly, since the positive electrode active material layer 31b easily extends and uniformly comes into contact with the insulating frame 6a, a gap between the positive electrode active material layer 31b and the insulating frame 6a can be easily eliminated. The cross-sectional angles of the insulating frame 6a and the cross-sectional angles of the positive electrode active material layer 31b are preferably set to correspond such that a total is 180°; however, from a viewpoint of achieving the above-described effects, it is not necessary to strictly set the total of the cross-sectional angles to 180°, and a certain degree of error (for example, about ±10°) is acceptable.

### Fifth Embodiment

A method of manufacturing a solid-state battery according to the present embodiment will be described with reference to FIGS. 15 to 18. The method of manufacturing a solid-state battery according to the present embodiment includes a positive electrode active material layer forming step of punching and cutting out a positive electrode active material layer 31c in a dry state. FIG. 15 corresponds to an X1 cross-sectional view and a Y1 cross-sectional view in FIG. 2. FIG. 15 is a diagram schematically illustrating a step of punching the positive electrode active material layer 31c in a dry state formed on the transfer sheet S1 by blades B1b, B2b, B3b, and B4b (positive electrode active material layer forming step). In the present embodiment, the blades B1b, B2b, B3b, and B4b are driven from a surface on which the transfer sheet S1 is present, and the positive electrode active material layer 31c is punched out together with the transfer sheet S1.

As illustrated in FIG. 15, angles θy5, θy6, θx5, and θx6 formed between end surfaces of the positive electrode active material layer 31c and a lamination surface of the positive electrode current collector layer 32 (hereinafter, the angles may be referred to as “cross-sectional angles”) can be determined by blade angles Dy5, Dy6, Dx5, and Dx6 of the blades B1b, B2b, B3b, and B4b, by the same method as in the fourth embodiment. The cross-sectional angles can be set to arbitrary angles. The cross-sectional angles may be set to correspond to cross-sectional angles of an insulating frame 6b described below, or may be angles unique to the positive electrode active material layer 31c. The cross-sectional angles may all be the same angle or may be different angles from each other. In the present embodiment, an example is illustrated in which each of the cross-sectional angles (inner angles) is less than 90°. Each of the cross-sectional angles (inner angles) can be set to, for example, 30° or more.

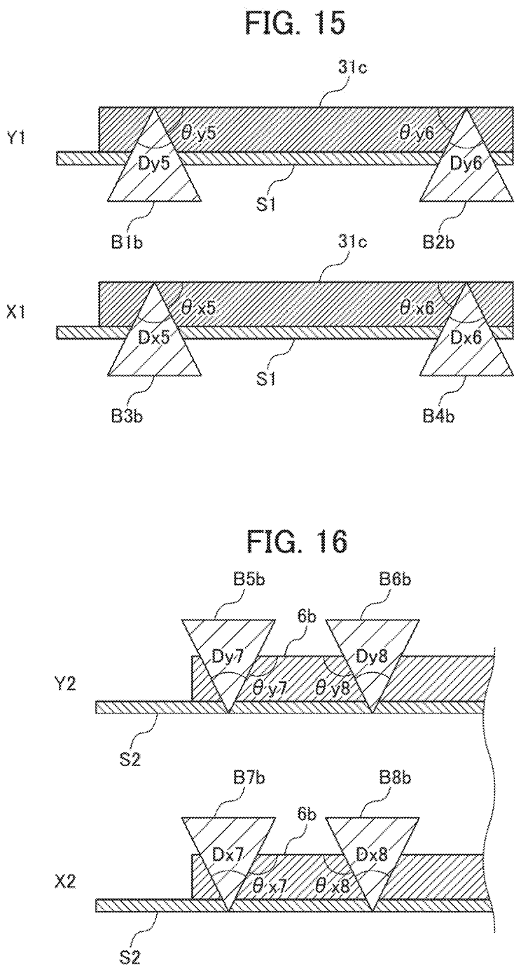

The method of manufacturing a solid-state battery according to the present embodiment includes an insulating frame forming step of punching and cutting out an insulating frame 6b in a dry state. Similarly to the fourth embodiment, FIG. 16 corresponds to part of an X2 cross-sectional view and a Y2 cross-sectional view in FIG. 3. FIG. 16 is a diagram schematically illustrating a step of punching the insulating frame 6b in a dry state formed on the transfer sheet S2 by blades B5b, B6b, B7b, and B8b (insulating frame forming step). In the present embodiment, the blades B5b, B6b, B7b, and B8b are driven from a surface on which the transfer sheet S2 of the insulating frame 6b is not present, and the insulating frame 6b is punched out. As illustrated in FIG. 16, the insulating frame 6b has a substantially trapezoidal shape in a cross-sectional shape along the lamination direction.

As illustrated in FIG. 16, angles θy7, θy8, θx7, and θx8 formed between end surfaces of the insulating frame 6b and a lamination surface of the positive electrode current collector layer 32 (hereinafter, the angles may be referred to as “cross-sectional angles”) can be determined by blade angles Dy7, Dy8, Dx7, and Dx8 of the blades B5b, B6b, B7b, and B8b, by the same method as in the fourth embodiment. The cross-sectional angles can be set to arbitrary angles. The cross-sectional angles may be set to correspond to the cross-sectional angles of the positive electrode active material layer 31c described above, or may be angles unique to the insulating frame 6b. The cross-sectional angles may all be the same angle, or may be different angles from each other. In the present embodiment, an example is illustrated in which each of the cross-sectional angles (inner angles) exceeds 90° and is set to correspond to the cross-sectional angles of the positive electrode active material layer 31c. Each of the cross-sectional angles (inner angles) can be set to, for example, 150° or less.

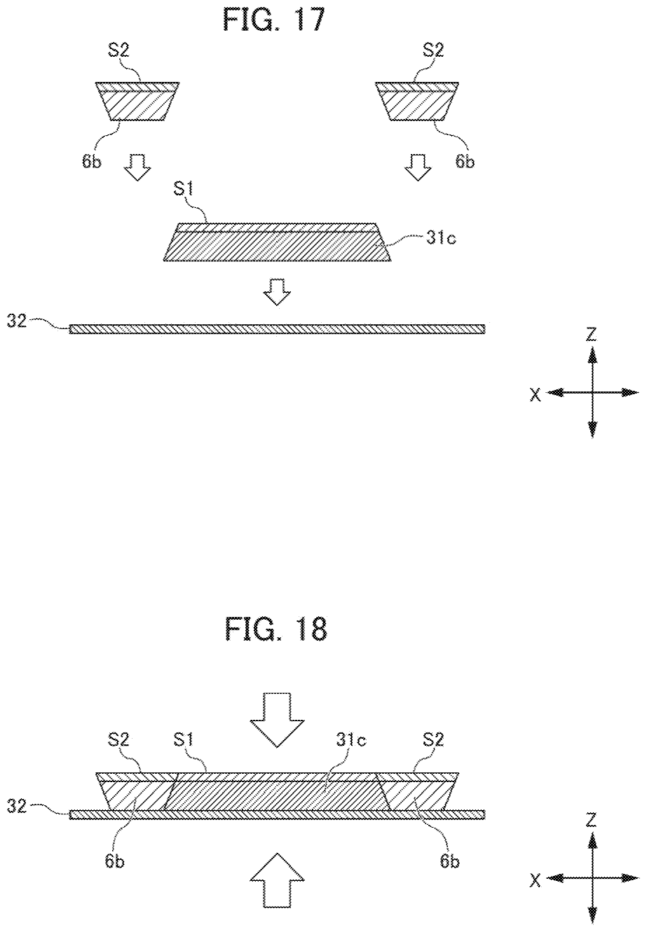

FIG. 17 is a schematic cross-sectional view along the lamination direction, and illustrates a placement step of placing the positive electrode active material layer 31c on an inner surface side of the insulating frame 6b obtained by the positive electrode active material layer forming step and the insulating frame forming step described above. In the present embodiment, first, the positive electrode active material layer 31c is disposed on the positive electrode current collector layer 32 and, thereafter, the insulating frame 6b is disposed on the positive electrode current collector layer 32 such that the positive electrode active material layer 31c is positioned on an inner surface side of the insulating frame 6b. In the present embodiment, each of the cross-sectional angles (inner angles) of the positive electrode active material layer 31c is less than 90°, and each of the cross-sectional angles (inner angles) of the insulating frame 6b exceeds 90°. Accordingly, the positive electrode active material layer 31c can be easily disposed on the inner surface side of the insulating frame 6b.

FIG. 18 is a schematic cross-sectional view along the lamination direction, and illustrates a first pressing step of pressing the insulating frame 6b and the positive electrode active material layer 31c after the placement step. FIG. 18 illustrates a state in which the insulating frame 6b and the positive electrode active material layer 31c are disposed on one surface of the positive electrode current collector layer 32; however, similarly to the above-described embodiments, the first pressing step may be performed in a state in which the insulating frame 6b and the positive electrode active material layer 31c are disposed on both surfaces of the positive electrode current collector layer 32. In the first pressing step, pressing is preferably performed without removing the transfer sheets S1 and S2, and the transfer sheets S1 and S2 are removed after pressing. By the first pressing step or a subsequent second pressing step, pressing may be performed such that a gap between the positive electrode active material layer 31c and the insulating frame 6b disappears. Accordingly, the energy density and/or the output density of the solid-state battery can be improved. In the present embodiment, the cross-sectional angles of the insulating frame 6b are set to correspond to the cross-sectional angles of the positive electrode active material layer 31c. Accordingly, effects similar to those of the fourth embodiment can be achieved. The cross-sectional angles of the insulating frame 6b and the cross-sectional angles of the positive electrode active material layer 31c are preferably set to correspond such that a total is 180°; however, a certain degree of error (for example, about ±10°) is acceptable.

### Other Embodiments

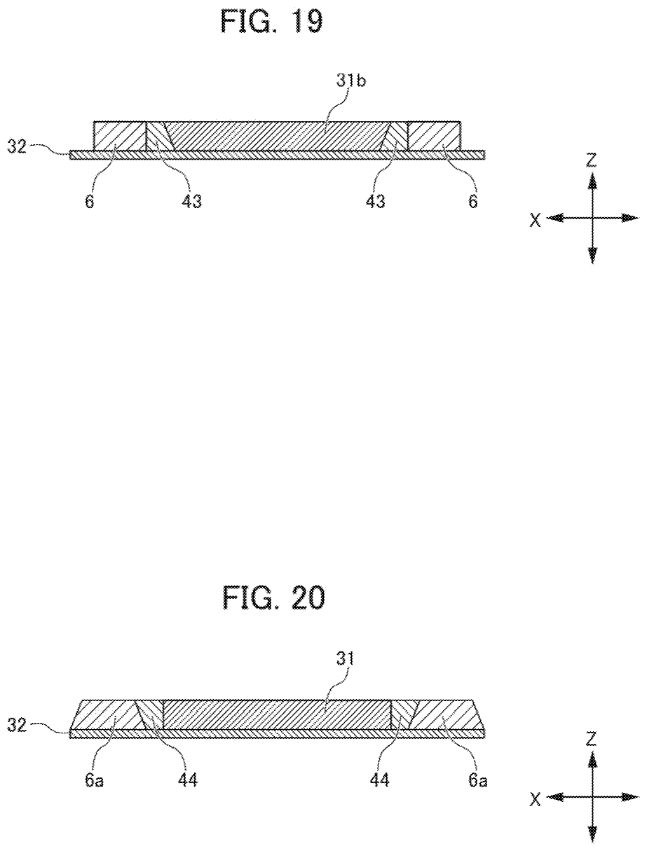

Other embodiments will be described with reference to FIGS. 19 and 20. FIGS. 19 and 20 are schematic cross-sectional views along the lamination direction, and illustrate a state in which a positive electrode active material layer is disposed on an inner surface side of an insulating frame obtained by the positive electrode active material layer forming step and the insulating frame forming step described above.

FIG. 19 is a diagram illustrating a combination of the positive electrode active material layer 31b of the fourth embodiment and the insulating frame 6 of the first to third embodiments, and FIG. 20 is a diagram illustrating a combination of the positive electrode active material layer 31 of the first to third embodiments and the insulating frame 6a of the fourth embodiment. As illustrated in FIGS. 19 and 20, in a case where a cross-sectional angle of the insulating frame is not set to correspond to a cross-sectional angle of the positive electrode active material layer, a gap may generate between the insulating frame and the positive electrode active material layer, even after the first pressing step. However, even in such a case, a solid-state battery can be configured by disposing solid electrolyte layers 43 and 44 in the gap between the insulating frame and the positive electrode active material layer. As a method of disposing the solid electrolyte layers 43 and 44 in the gap between the insulating frame and the positive electrode active material layer, similarly to the third embodiment, a method of causing a solid electrolyte slurry to flow into the gap can be employed. The combinations of shapes of the positive electrode active material layer and the insulating frame are not limited to those illustrated in the drawings described above, and arbitrary combinations are possible, such as a combination of the positive electrode active material layer 31 and the insulating frame 6b, or a combination of the positive electrode active material layer 31c and the insulating frame 6.

Preferred embodiments of the method of manufacturing a solid-state battery according to the present invention have been described above. The present invention is not limited to the above-described embodiments, and various modifications can be made as appropriate without departing from the scope of the present invention or impairing the effects of the present invention.

### EXPLANATION OF REFERENCE NUMERALS

1: solid-state battery
2: negative electrode layer
3: positive electrode layer
31, 31a, 31b, 31c: positive electrode active material layer
32, 32a: positive electrode current collector layer
4, 41, 42, 43, 44: solid electrolyte layer
6, 6a, 6b: insulating frame

What is claimed is:

1. A method of manufacturing a solid-state battery having a laminated structure in which a negative electrode layer, a solid electrolyte layer, and a positive electrode layer are laminated in this order, the positive electrode layer including a positive electrode active material layer, and an insulating frame being disposed at an outer edge of the positive electrode active material layer in a direction orthogonal to a lamination direction of the laminated structure, the method comprising:
(A) a positive electrode active material layer forming step of punching and cutting out the positive electrode active material layer in a dry state;
(B) an insulating frame forming step of punching and cutting out the insulating frame in a dry state;
(C) a placement step of placing the positive electrode active material layer formed in the positive electrode active material layer forming step (A) on an inner surface side of the insulating frame formed in the insulating frame forming step (B);
(D) a first pressing step of pressing the insulating frame and the positive electrode active material layer after the placement step (C);
(E) a lamination step of laminating at least the solid electrolyte layer on the positive electrode active material layer and the insulating frame; and
(F) a second pressing step of pressing a laminate obtained in the lamination step (E).

2. The method of manufacturing a solid-state battery according to claim 1, wherein formation of the positive electrode active material layer is entirely performed with a dry manufacturing process.

3. The method of manufacturing a solid-state battery according to claim 1, wherein the placement step (C) is a step of transferring the positive electrode active material layer to a positive electrode current collector layer, and subsequently transferring the insulating frame to the positive electrode current collector layer such that the positive electrode active material layer is disposed on an inner surface side of the insulating frame.

4. The method of manufacturing a solid-state battery according to claim 3, wherein
in a cross-sectional shape along the lamination direction, the positive electrode active material layer has a length of a side adjacent to the solid electrolyte layer which is shorter than a length of a side adjacent to the positive electrode current collector layer, and
an angle formed between an end surface of the positive electrode active material layer and a lamination surface of the positive electrode current collector layer is between 30° and 150° inclusive.

5. The method of manufacturing a solid-state battery according to claim 1, wherein the placement step (C) is a step of transferring the insulating frame to a positive electrode current collector layer, and subsequently transferring the positive electrode active material layer to the positive electrode current collector layer such that the positive electrode active material layer is disposed on an inner surface side of the insulating frame.

6. The method of manufacturing a solid-state battery according to claim 5, wherein
in a cross-sectional shape along the lamination direction, the positive electrode active material layer has a length of a side adjacent to the positive electrode current collector layer which is shorter than a length of a side adjacent to the solid electrolyte layer, and
an angle formed between an end surface of the positive electrode active material layer and a lamination surface of the positive electrode current collector layer is between 30° and 150° inclusive.

7. The method of manufacturing a solid-state battery according to claim 1, wherein
in the placement step (C), a gap is formed between the insulating frame and the positive electrode active material layer, and
in the first pressing step (D) or the second pressing step (F), the insulating frame and the positive electrode active material layer extend and come into contact with each other.

8. The method of manufacturing a solid-state battery according to claim 1, wherein
in the placement step (C), a gap is formed between the insulating frame and the positive electrode active material layer,
the gap does not disappear in the first pressing step (D), and
in the lamination step (E), a solid electrolyte slurry for forming the solid electrolyte layer is applied to lamination surfaces of the insulating frame and the positive electrode active material layer, and application thereof, the solid electrolyte slurry flows into the gap.

9. The method of manufacturing a solid-state battery according to claim 1, wherein a thickness of the solid electrolyte layer is between 1 μm and 40 μm inclusive.

10. The method of manufacturing a solid-state battery according to claim 1, wherein a level difference in the lamination direction between the positive electrode active material layer and the insulating frame in the solid-state battery is equal to or less than two-thirds of a thickness of the solid electrolyte layer.

11. The method of manufacturing a solid-state battery according to claim 1, wherein a pressing pressure in the second pressing step (F) is higher than a pressing pressure in the first pressing step (D).

12. The method of manufacturing a solid-state battery according to claim 1, wherein a pressing pressure in the first pressing step (D) is between 10 MPa and 200 MPa inclusive.
